(19) United States
(12) Patent Application Publication
(10) Pub. No.: US 2026/0017918 A1
(43) Pub. Date: Jan. 15, 2026

(54) INFORMATION PROCESSING DEVICE AND METHOD, AND COMPUTER-READABLE STORAGE MEDIUM

(71) Applicant: Sony Group Corporation, Tokyo (JP)

(72) Inventor: Linghao SHEN, Shenzhen, Guangdong (CN)

(73) Assignee: Sony Group Corporation, Tokyo (JP)

(21) Appl. No.: 18/994,710

(22) PCT Filed: Jul. 18, 2023
(86) PCT No.: PCT/CN2023/107835

§ 371 Date: Jan. 15, 2025

(30) Foreign Application Priority Data
Jul. 22, 2022 (CN) 202210870640.2

(51) Int. Cl. G06V 10/46; G06V 10/25; G06V 10/764

(52) U.S. Cl. CPC G06V 10/462; G06V 10/25; G06V 10/764

(57) ABSTRACT

The present application provides an information processing device and method, and a computer-readable storage medium. The information processing device comprises a processing circuit which is configured to: generate a saliency map of a sample image on the basis of a predetermined model which processes a task for the sample image, wherein the saliency map reflects the degree of attention to objects at different positions in the sample image when the predetermined model processes the task; and adjust, on the basis of the saliency map and the labeling area in the sample image, the parameters of the image signal processor which generates the sample image, such that the difference between the task processing result and the labeling value of the sample image meets a preset condition.

This application claims priority to Chinese Patent Application No. 202210870640.2 titled “INFORMATION PROCESSING DEVICE AND METHOD, AND COMPUTER-READABLE STORAGE MEDIUM”, filed on Jul. 22, 2022 with the China National Intellectual Property Administration (CNIPA), which is incorporated herein by reference in its entirety.

### FIELD

The present disclosure relates to the technical field of information processing, and in particular to tuning an image signal processor. More specifically, the present disclosure relates to an information processing apparatus and method, and a computer-readable storage medium.

### BACKGROUND

An image signal processor (ISP) is a hardware underlying image processing apparatus that converts an original illumination signal captured by an optical sensor into an image that can be viewed by the human eye on various devices. Such ISP is widely applied in current digital cameras, mobile phone cameras and other devices, performing a great impact on a quality of a final image. Generally, the ISP is provided with a large number of configuration parameters for adjustment, and ISP manufacturers have experts to tune (optimize) the configuration parameters. Generally, a tuning target of the ISP is human visual perception, such as texture clarity, visual noise, or the like. With the development of machine learning, a large number of images are used for computer vision tasks. Therefore, a large number of ISP tuning for advanced computer vision tasks such as autonomous driving has appeared. How to realize ISP tuning is a hot topic at present.

### SUMMARY

A brief summary of the present disclosure is given below, to provide a basic understanding of some aspects of the present disclosure. It should be understood that the following summary is not an exhaustive summary of the present disclosure. It is not intended to determine a key or important part of the present disclosure, nor does it intend to limit the scope of the present disclosure. Its objective is merely to present some concepts in a simplified form, which serves as a preamble of a more detailed description to be discussed later.

According to an aspect of the present disclosure, an information processing apparatus is provided, including processing circuitry configured to: generate a saliency map of a sample image, based on a predetermined model performing task processing on the sample image, where the saliency map reflects, when the predetermined model performs the tasking processing, a degree of importance on objects at different positions in the sample image, and adjust, based on the saliency map and marked region(s) in the sample image, parameter(s) of an image signal processor for generating the sample image, to make a difference between a result of the task processing and a marked value of the sample image satisfy a predetermined condition.

In the information processing apparatus according to the embodiment of the present disclosure, the saliency map can be automatically generated based on the predetermined model and the sample image, without the need for experts. In addition, saliency maps of different sample images are different from each other, realizing improved flexibility and pertinence. The ISP is not simplified in the information processing apparatus 100 according to the embodiment of the present disclosure, so that the information processing apparatus is closer to real applications. The saliency map includes information about a decision-making process of the predetermined model in the task processing (for example, a degree of importance on objects at different positions in the sample image when the predetermined model performs the tasking processing). In the process of adjusting the parameter of the ISP, the saliency map changes more uniformly and frequently than the task evaluation indicator during a change of a quality of the sample image. Therefore, using the saliency map can be more conducive to tuning the ISP parameter, and can achieve a better effect than directly tuning the ISP based on the task evaluation indicator, achieving an improved accuracy of the task processing.

According to another aspect of the present disclosure, an information processing method is provided, including: generating a saliency map of a sample image, based on a predetermined model performing task processing on the sample image, where the saliency map reflects, when the predetermined model performs the tasking processing, a degree of importance on objects at different positions in the sample image; and adjusting, based on the saliency map and marked region(s) in the sample image, parameter(s) of an image signal processor for generating the sample image, to make a difference between a result of the task processing and a marked value of the sample image satisfy a predetermined condition.

According to other aspects of the present disclosure, there are further provided a computer program code and a computer program product for implementing the above-described information processing method, and a computer-readable storage medium having the computer program code for implementing the information processing method recorded thereon.

### BRIEF DESCRIPTION OF THE DRAWINGS

For a further illustration of the above and other advantages and features of the present disclosure, embodiments of the present disclosure are described in detail hereinafter in conjunction with accompanying drawings. The drawings, together with the detailed description below, are incorporated into and form a part of the specification. Elements having the same function and structure are denoted by same reference signs. It should be noted that the drawings illustrate merely typical embodiments of the present disclosure and should not be construed as a limitation to the scope of the present disclosure. In the drawings:

FIG. 1 shows a block diagram of functional modules of an information processing apparatus according to an embodiment of the present disclosure.

FIG. 2 is a schematic diagram showing an application scenario according to an embodiment of the present disclosure.

FIG. 3 is a schematic flow chart illustrating tuning of an image signal processor according to an embodiment of the present disclosure.

FIG. 4 shows prediction results of a predetermined model on a sample image after tuning through an existing method and tuning on an image signal processor based on a saliency score, respectively.

FIG. 5 shows a graph of comparison of tuning based on a saliency score with an existing method, when the size of a test data set changes.

FIG. 6 shows a graph of comparison of tuning based on a saliency score with an existing method, when in a difficult scenario.

FIG. 7A to FIG. 7D show schematic diagrams of tuning by calculating a saliency score based on different objects and tuning through an existing method.

FIG. 8 is a schematic diagram illustrating an effect of tuning of an image signal processor based on a saliency score calculated according to different importance masks according to an embodiment of the present disclosure.

FIG. 9 is a flowchart illustrating an exemplary process of an information processing method according to an embodiment of the present disclosure.

FIG. 10 is a block diagram of an exemplary structure of a personal computer applicable in an embodiment of the present disclosure.

### DETAILED DESCRIPTION

Exemplary embodiments of the present disclosure are described below in conjunction with the drawings. For the sake of clarity and conciseness, not all features of an actual embodiment are described in the specification. However, it is to be appreciated that numerous implementation-specific decisions shall be made during developing any of such actual implementations so as to achieve specific objectives of a developer, for example, to comply with system- and business-related constraining conditions which will vary from one implementation to another. Furthermore, it should be understood that the development work, although may be complicated and time-consuming, is only a routine task for those skilled in the art benefiting from the present disclosure.

Here, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

Embodiments of the present disclosure are described in detail below in conjunction with the drawings.

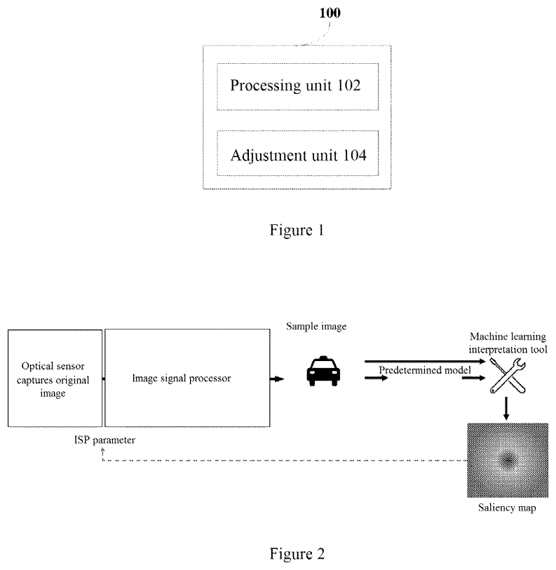

FIG. 1 shows a block diagram of functional modules of an information processing apparatus 100 according to an embodiment of the present disclosure. As shown in FIG. 1, the information processing apparatus 100 includes a processing unit 102 and an adjustment unit 104. The processing unit 102 may be configured to generate a saliency map of a sample image, based on a predetermined model performing task processing on the sample image, where the saliency map reflects, when the predetermined model performs the tasking processing, a degree of importance on objects at different positions in the sample image. The adjustment unit 104 may be configured to adjust, based on the saliency map and marked region(s) in the sample image, parameter(s) of an image signal processor for generating the sample image, to make a difference between a result of the task processing and a marked value of the sample image satisfy a predetermined condition.

The processing unit 102 and the adjustment unit 104 may be implemented by one or more processing circuits. The processing circuitry may be implemented as a chip, for example.

As an example, an input to an ISP is an original image captured by an optical sensor. For example, the original image may be a 24-bit Bayer image. However, the above is only an example, and those skilled in the art can understand that the original image may be in another form. An output of the ISP (i.e., an image obtained from processing by the ISP) is the sample image mentioned above. For example, the sample image may be a 3-channel 8-bit RBG image. However, the above is only an example, and those skilled in the art can understand that the sample image may be in another form.

The ISP may be implemented, for example, by an ISP simulator. An input to the ISP simulator is an original image sample in a test data set. For example, the ISP operates as a black box, and the ISP simulator itself may also be a black box, without knowing an internal structure thereof. Preferably, the ISP simulator may correspond to a hardware ISP of the Sony FUJI sensor, whose function includes at least one of demosaick, white balance, noise reduction, sharpening, tone mapping, and bit length compression. The ISP simulator may simulate a specific hardware ISP, having parameters in one-to-one correspondence with the hardware ISP. An effect obtained by a set of parameters on the ISP simulator is consistent with an effect on the corresponding hardware ISP.

For example, a marked region in the sample image may correspond to a marked region in the original image or the original image sample.

In the following, unless otherwise specified, there is no distinction between the ISP and the ISP simulator, nor between the original image and the original image sample.

As an example, the predetermined model may be a computer vision task model. An input to the computer vision task model is the above-mentioned sample image, and an output is a result corresponding to the task processing. The computer vision task model may be, for example, a deep learning model, such as a convolutional neural network (CNN). For example, the CNN may be a neural network which is trained for performing a specific task processing.

The task processing may include a classification task, an object detection task (i.e., a subject detection task), and the like. Other examples of the task processing may be envisaged in the art, which are not described here.

The same or different computer vision task models may be adopted for different task processing.

In the present disclosure, the saliency map is for quantifying decision-making process information during the predetermined model performs the task processing (for example, a degree of importance on objects at different positions in the sample image when the predetermined model performs the task processing). The result of the task processing may be optimized quantitatively based on the saliency map. Parameter(s) of the ISP is adjusted based on the saliency map and the marked region in the sample image. The ISP is called to process the original image based on the new parameter, so that an updated sample image is obtained, that is, a quality of the sample image outputted by the ISP after the adjustment is changed. In a process of iteratively adjusting the parameters of the ISP, the quality of the sample image is continuously changed, achieving an overlap of an important region in the saliency map (for example, a region corresponding to a to-be-detected object) with the marked region as much as possible. The saliency map changes more uniformly and frequently than a task evaluation indicator. Therefore, using the saliency map can be more conducive to tuning the ISP parameter, and can achieve a better effect than directly tuning based on the task evaluation indicator. For example, the task evaluation indicator for the classification task may include an accuracy or F1 value; the task evaluation indicator for the object detection task may include a mAP (mean average precision). For example, the task evaluation indicator corresponding to the task processing performed by the predetermined model on the sample image may be calculated based on marking information contained in the sample image, such as the marked region.

For example, the information processing apparatus 100 may call an optimizer to adjust the parameter(s) of the ISP. The optimizer may be provided in the information processing apparatus 100 as a part of the information processing apparatus 100, for example, or the optimizer may be provided outside the information processing apparatus 100. An tuning goal of the optimizer is to tune the parameter of the ISP so that a difference between the result of the task processing and a marked value of the sample image satisfies a predetermined condition. For the computer vision task, the tuning goal is to enable the sample image outputted by the ISP to obtain a high task evaluation indicator in the current computer vision task. The optimizer may be, for example, a CMA-ES (Covariance Matrix Adaptation Evolution Strategy) optimizer. For example, the information processing apparatus 100 may randomly select a set of numbers as initial values of the optimizer, where the quantity of the numbers is the same as the quantity of internal parameters of the optimizer. As an example, the information processing apparatus 100 may call the optimizer, and the optimizer may generate a set of consecutive values in a quantity same as the quantity of the ISP parameters. That is, the optimizer generates values for the ISP parameters, and these values are in a one-to-one correspondence with the parameters of the ISP. The continuous values generated are processed based on a range and value type of the actual ISP parameter to comply with an ISP parameter requirement. Processing on the continuous values includes: operations of truncating, scaling or reflection, and the like are performed on values beyond a corresponding parameter range, to make the values comply with the parameter range requirement. In a case where the parameter type is discrete, the continuous values are converted into discrete values through rounding. Then, the processed values are used to set the parameter of the ISP, and the ISP is called to process the original image based on the new parameter, so that an updated sample image is obtained.

As an example, those skilled in the art may determine the predetermined condition in advance based on experience or application scenarios. For example, the predetermined condition includes that a difference between the result of the task processing and the marked value of the sample image is less than a predetermined threshold (or that the task evaluation indicator of a currently processed sample image on the task processing is higher than a preset indicator threshold), or the number of times the parameter of the ISP is iteratively adjusted (or the number of times the task processing is iteratively performed) reaches a predetermined number of times, or the result of the task processing is not improved after a number of consecutive iterations.

In the conventional technology, methods for optimizing an ISP mainly follows the following ideas and have corresponding problems.

In a first idea according a conventional technology, the ISP is automatically tuned based on expert understanding. For example, it is concluded, based on expert understanding, that a sharpness and contrast of an image is helpful for registration, pedestrian detection, and other computer vision tasks. Therefore, an image feature that experts consider effective is enhanced through the ISP. Although this idea does not require manual adjustment by experts, it still requires domain knowledge from the experts. Meanwhile, there is usually only a shallow relationship between an expert conclusion and a task evaluation, which affects a final effect.

In a second idea according to a conventional technology, a task evaluation indicator is utilized as an tuning target, and the ISP is approximated or partially optimized in order to simplify the tuning. For example, in an implementation, the ISP function is abstracted into several CNNs and trained as a whole for downstream tasks. Such idea has a problem that there is no accurate correspondence between the CNNs and ISP parameters, and a processing result cannot be applied to the tuning of the ISP parameters, and thereby existing hardware cannot be utilized. In addition, in another implementation, independent modules in the ISP are optimized separately, which reduces the difficulty of tuning, but ignores mutual influence of the modules, so that only a suboptimal solution can be obtained. In addition, in yet another implementation, a proxy neural network is trained to simulate the entire ISP. However, since the noise caused by the simulation cannot be ignored, a result obtained based on the proxy neural network is suboptimal.

In a third idea according to a conventional technology, the ISP is used as a black box and the task evaluation indicator is used as an optimization target. Parameter(s) are directly tuned through the black box optimizer. A main difficulty lies in the large number of ISP parameters. Moreover, the task evaluation indicator includes only a final prediction effect of the model. Hence, information is simple, making the optimization difficult. For example, in one implementation, a CMA-ES optimizer is used to perform black-box tuning of the ISP parameter. Hence, individual parameter can be explicitly tuned while considering the ISP as a whole. A main problem thereof is that the tuning relies on only an evaluation score of the computer vision task, and therefore a tuning efficiency is low and an optimization effect is not good.

However, in the information processing apparatus 100 according to the embodiment of the present disclosure, the parameter of the ISP is adjusted based on the saliency map, that is, the ISP is tuned so that the result of the task processing of the predetermined model is optimized. Compared with the first idea, the saliency map can be automatically generated based on the predetermined model and the sample image, without the need for experts. In addition, saliency maps of different sample images are different from each other, realizing improved flexibility and pertinence. Compared with the second idea, the ISP is not simplified in the information processing apparatus 100 according to the embodiment of the present disclosure, so that the information processing apparatus is closer to real applications. Compared with the third idea, the saliency map includes information about a decision-making process during the task processing performs the predetermined model (for example, a degree of importance on objects at different positions in the sample image when the predetermined model performs the tasking processing). In the process of iteratively adjusting the parameter of the ISP, the saliency map changes more uniformly and frequently than the task evaluation indicator during a change of a quality of the sample image. Therefore, using the saliency map can be more conducive to tuning the ISP parameter, and can achieve a better effect than directly tuning the ISP based on the task evaluation indicator, achieving an improved accuracy of the task processing.

As an example, the information processing apparatus 100 may take data in a form of data stream as an input, call the ISP simulator for processing, and output the processed sample image to the predetermined model in a form of data stream. Since a test data set contains multiple samples, this is beneficial to improving an operating efficiency of the information processing apparatus 100 (i.e., increasing a speed of automatic tuning of the ISP) and saving system resources.

As an example, the processing unit 102 may be configured to obtain at least one heat map by using a machine learning interpretation tool based on an output obtained after inputting the sample image into the predetermined model; and generate the saliency map based on the at least one heat map.

For example, heat maps may be generated for different types and sizes of objects (subjects) in the sample images, thereby generating multiple heat maps.

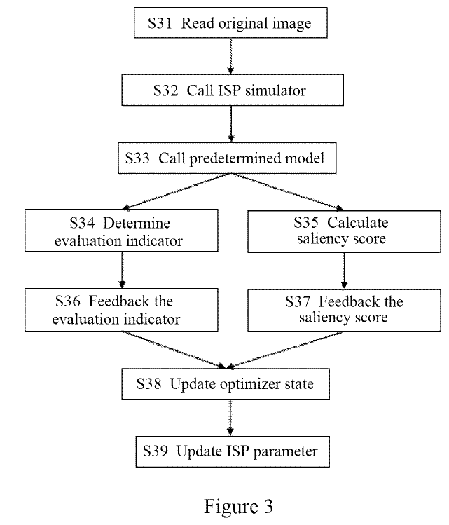

FIG. 2 is a schematic diagram showing an application scenario according to an embodiment of the present disclosure.

As shown in FIG. 2, an optical sensor captures the original image and inputs to the ISP. The ISP processes the original image and outputs the sample image. For example, functions of the ISP include at least one of: demosaick, white balance, denoise, sharpen, tone and color correction, and bit length compression. The predetermined model processes the sample image, obtains a model output, and records an intermediate activation value result of processing of the predetermined model. A machine learning interpretation tool may generate a heat map by using the model output and the intermediate activation value result, for example, and generate a saliency map based on the heat map. Parameter(s) of the ISP are adjusted based on the saliency map and a marked region in the sample image, to make a difference between the output result of the predetermined model and a marked value of the sample image satisfy a predetermined condition.

As an example, the machine learning interpretation tool may be a deep learning interpretation tool. As an example, the machine learning interpretation tool includes at least one of: Grad-CAM (gradient-weighted class activation mapping), Grad-CAM++, XGrad-CAM (improved class activation mapping), Ablation-CAM (ablation class activation mapping), Score-CAM (score-based class activation mapping), and guided back-propagation.

As an example, a size of the saliency map is the same as a size of the sample image, and a pixel value of a pixel in the saliency map reflects a contribution of the pixel to the task processing. For example, in a case where the task processing is a classification task, a pixel value of a pixel in the saliency map reflects a contribution of the pixel to the classification task. For example, in a case where the task processing is an object detection task, a pixel value of a pixel in the saliency map reflects a contribution of the pixel to the object detection task.

As an example, in a case where the at least one heat map includes only one heat map, the saliency map is generated by normalizing pixel values of pixels in the one heat map.

For example, in a case where only one heat map exists, the saliency map is generated by using the following equation 1.

$${x}_{i}^{′} = \frac{{x}_{i}}{Max ( \{ {x}_{j} \vert for j ∈ 1 , … , n \} )} \qquad ( Equation 1 )$$

Assume that there are n pixels in the heat map. In equation 1, xᵢ represents a pixel value of the i-th pixel in the heat map. Max ( ) represents an operation of taking a maximum value, and x′ᵢ represents a saliency value, which is scaled to 0 to 1, of the i-th pixel in the saliency map.

As an example, in a case where the at least one heat map includes multiple heat maps obtained for different objects included in the sample image, the saliency map is generated by normalizing pixel values of pixels in the multiple heat maps and averaging the normalized pixel values of pixels at a same position in the multiple heat maps.

For example, in a case where there are multiple heat maps, the pixel values of the pixels in each heat map are normalized according to Equation 1, and then the saliency map is generated by using the following Equation 2.

$${y}_{i} = \frac{1}{K} {\sum }_{k = 1}^{K} {x}_{ki}^{′} \qquad ( Equation 2 )$$

It is assumed that there are K heat maps in total. In Equation 2, x′ₖᵢ represents a normalized value of the i-th pixel in the k-th heat map, and y; represents a pixel value of the i-th pixel in the generated saliency map. Hereinafter, for convenience, yᵢ is always used to represent the pixel value of the i-th pixel in the saliency map.

As an example, the processing unit 102 may be configured to calculate a saliency score corresponding to the sample image based on the saliency map and the marked region, and the adjustment unit 104 may be configured to perform the adjustment based on the saliency score.

The saliency score calculated based on the saliency map and the marked region can more directly reflect an effect of the task processing performed by the predetermined model for the sample image. The saliency score changes directly with the quality of the sample image. Therefore, the saliency score can guide the tuning of the ISP more quickly, so that a speed of the automatic tuning of the ISP is improved. In addition, the saliency score can provide quality information of the sample image to guide the tuning of the ISP even when the task evaluation indicator remains unchanged. Hence, the accuracy of task processing can be improved.

As an example, in a case where the task processing is a classification task, the marked region in the sample image is a region for determining a type of the sample image. For example, the marked region may be an image area based on which the experts determine an image type.

As an example, in a case where the task processing is an object detection task, the marked region in the sample image is a bounding box marked as an object in the sample image.

As an example, the adjustment unit 104 may be configured to iteratively adjust the parameter(s) of the ISP with a goal of increasing the saliency score. In a process of iteratively adjusting the parameter of the ISP, the quality of the sample image outputted by the ISP after adjustment continuously changes until a difference between a result of the task processing and a marked value of the sample image satisfies the above-mentioned predetermined condition.

As an example, the processing unit 102 may be configured to: calculate a sum of pixel values of pixels located within the marked region(s) in the saliency map, as a first value, and calculate a sum of pixel values of all pixels in the saliency map, as a second value; and calculate a ratio of the first value to the second value, as the saliency score.

For example, the saliency score s may be calculated through the following Equation 3.

$$S = \frac{{\sum }_{i = 1}^{n} {y}_{i} {r}_{i}}{{\sum }_{i = 1}^{n} {y}_{i}} \qquad ( Equation 3 )$$

In Equation 3, yᵢ represents a pixel value of the i-th pixel in the saliency map. If the i-th pixel is located within the marked region, there has rᵢ=1; and otherwise, rᵢ=0.

As an example, the processing unit 102 may be configured to: generate, based on the saliency map, an importance mask for reflecting importance of pixels in the saliency map; and calculate the saliency score based on the importance mask and the marked region(s).

Hereinafter, the pixel value in the saliency map is sometimes referred to as a saliency value.

Compared with the saliency map, the importance mask can eliminate an influence caused by the accumulation of a large number of extremely small saliency values caused by noise.

As an example, the processing unit 102 may be configured to retain pixel(s) in the saliency map whose pixel values are greater than a first predetermined threshold, and set the pixel value of any other pixels in the saliency map to 0, thereby generating the importance mask.

For example, those skilled in the art may set the first predetermined threshold in advance based on experience or an application scenario.

For example, given the first predetermined threshold, the importance mask retains only a pixel in the saliency map whose pixel value is greater than the first predetermined threshold, while masking out any pixel whose pixel value is less than or equal to the first predetermined threshold (setting the pixel value to 0).

As an example, in the importance mask, the pixel value of the retained pixel(s) is the pixel value of the pixel at a corresponding position in the saliency map, or a value calculated based on the pixel value of the pixel at the corresponding position in the saliency map.

For example, in the importance mask, the pixel value of the retained pixel may be an original value of saliency value, or the salient value may undergo a certain mathematical transformation, such as taking squares, taking root, directly setting to 1, and the like.

As an example, the processing unit 102 may be configured to: calculate a first quantity of pixels in the importance mask that are located within the marked region(s) and whose pixel values are greater than a second predetermined threshold; calculate a second quantity of pixels in the importance mask whose pixel values are greater than the predetermined second threshold, and calculate a ratio of the first quantity to the second quantity, as the saliency score.

For example, those skilled in the art may set the second predetermined threshold in advance based on experience or an application scenario.

As an example, the marked region is at least a part of regions which are from regions for marking multiple objects in the sample image and correspond to at least a part of the multiple objects. Hence, saliency scores may be calculated respectively based on different objects in the sample image, for example, the saliency scores are calculated respectively based on objects of a specific category and/or a specific size in the sample image.

For example, it is assumed that the sample image includes objects of different categories, such as a vehicle, a pedestrian, and a rider. For example, when at least part of the region corresponds to any object from a vehicle, a pedestrian, and a rider, the saliency score may be calculated based on the object. For example, when at least part of the region corresponds to one object from a vehicle, a pedestrian, and a rider, the saliency score may be calculated based on the one object; when at least part of the region corresponds to any two objects from a vehicle, a pedestrian, and a rider, the saliency score may be calculated based on the two objects; and when at least part of the region corresponds to a vehicle, a pedestrian, and a rider, the saliency score may be calculated based on the vehicle, the pedestrian, or the rider.

As an example, the processing unit 102 may be configured to adjust the parameter(s) based on the saliency score and an evaluation indicator for the task processing of the predetermined model. In this way, the accuracy of the task processing can be further improved.

As mentioned above, for example, the task evaluation indicator for the classification task may include an accuracy or F1 value; the task evaluation indicator for the object detection task may include a mAP. The corresponding evaluation indicator is calculated after the predetermined model performs the task processing on the sample image.

As an example, the processing unit 102 may be configured to adjust the parameter(s) based on a sum of a first value and a second value, where the first value is obtained by multiplying the saliency score by a first predetermined weight, and the second value is obtained by multiplying the evaluation indicator by a second predetermined weight.

As an example, the first predetermined weight is a ratio of the number of pixels located in the marked region in the saliency map to the number of all pixels in the saliency map.

For example, the first predetermined weight s may be calculated through the following Equation 4.

$$W = \frac{{\sum }_{i = 1}^{n} {r}_{i}}{n} \qquad ( Equation 4 )$$

In Equation 4, if the i-th pixel in the saliency map is located within the marked region, there has rᵢ=1; and otherwise, rᵢ=0.

For example, those skilled in the art may set the first predetermined weight w in advance based on experience or an application scenario.

For example, those skilled in the art may set the second predetermined weight in advance based on experience or an application scenario.

The processing unit 102 may perform the above adjustment based on the salience score in combination with other indicators besides the evaluation indicators. Other indicators may be, for example, a mean and variance of computer vision model batch normalization (BN), or evaluation values obtained by evaluating a difference in data distribution of the sample image before and after the tuning.

For example, the optimizer may perform the ISP tuning based on an evaluation score for the value generated by the ISP parameters. For example, the optimizer may use the saliency score as the evaluation score for the value generated by the current optimizer, or may use a sum of a first value and a second value as the evaluation score for the value generated by the current optimizer, where the first value is obtained by multiplying the saliency score by a first predetermined weight and the second value obtained by multiplying the evaluation indicator by a second predetermined weight. For example, in order to perform optimization more stably, it is preferable to perform the process for the optimizer repeatedly for a specific number of times to obtain multiple sets of values generated by the current optimizer for the ISP parameter and evaluation scores corresponding to each set of values. For example, the specific number of times may be 16 times. The information processing apparatus 100 may input the multiple sets of values and the corresponding evaluation scores into the optimizer to update a state of the optimizer. The optimizer compares the evaluation scores and updates an internal state. Hence, a newly generated value for the ISP parameter is more likely to be closer to the value with a higher evaluation score, and more likely to be farther away from the value with a lower evaluation score. For example, the optimizer may update the internal state based on a feedback evaluation score received from the information processing apparatus 100. The optimizer ranks the evaluation scores from high to low, uses values generated by the optimizer for the ISP parameter and corresponding to the highest-ranking evaluation scores as positive values, and uses values generated by the optimizer for the ISP parameter and corresponding to the lowest ranking evaluation scores as negative values. The optimizer updates the internal state based on the positive values and the negative values, so that a mean of values newly generated by the optimizer for the ISP parameter is closer to the positive values and farther away from the negative values.

In order to obtain a better result of the ISP tuning, it is preferable to repeatedly update the state of the optimizer until the evaluation score fails to be improved compared with the previous iteration for consecutive a times or reaching preset b times. Preferably, the a times may refer to 50 times, and the b times may be 500 times.

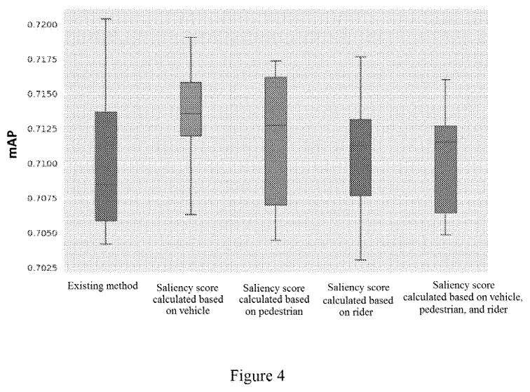

FIG. 3 is a schematic flow chart illustrating tuning of an ISP according to an embodiment of the present disclosure.

In step S31, an original image in the test data set is read. In step S32, the ISP simulator is called to process the original image to obtain a sample image. In step S33, the sample image is processed using a predetermined model. In step S34, an evaluation indicator obtained after the predetermined model processes the sample image is determined. In step S35, a saliency score is calculated. In steps S36 and S37, the evaluation indicator and the saliency score are fed back to the optimizer. In step S38, a state of the optimizer is updated based on the evaluation indicator and the saliency score. In step S39, parameter(s) of the ISP are updated based on the updated state of the optimizer. Steps S32 to S39 are performed iteratively, until a difference between a result of the task processing on the sample image by the predetermined model and a marked value of the sample image satisfies a predetermined condition.

Application examples according to the information processing apparatus 100 are introduced below.

### (1) Application 1

In Application Embodiment 1, modified Grad-CAM and Yolov3 object detection models are used to calculate a saliency map and a saliency score of a sample image, so that a determination process is visualized.

For example, the classic Grad-CAM technology is utilized to explain an image classification model. A characteristic of the image classification model is that a final layer output is a single value representing a category confidence. The object detection model represented by Yolov3 is different from the image classification model in that the final layer output is multiple values representing confidence of a detection frame and multiple values representing the category confidence. In addition, such object detection model has multiple parallel final layers, which correspond to detection of objects of different sizes.

In the application 1, the saliency map corresponding to an object in a final layer of the Yolov3 object detection model is calculated through the following steps.

(1) A detection frame confidence is multiplied with a category confidence, according to positions, to obtain multiple final confidences.

(2) An output whose final confidence is less than a threshold is deleted, where the threshold is preferably 0.001, 0.1, or 0.5.

(3) Detection frames having the same category and an excessive overlap area are deleted using the non-maximum suppression technology, and a model output corresponding to the remaining detection frame(s) is recorded.

(4) Final confidences of the recorded model outputs are averaged to obtain a single confidence value.

(5) The saliency map is calculated based on the single confidence value, by using the Grad-CAM technology.

Since Yolov3 has multiple parallel final layers, for example, the final saliency map may be obtained by combining multiple saliency maps corresponding to objects of different sizes through the following steps.

(1) The saliency value in each saliency map is divided by the maximum value of the corresponding saliency map to obtain a normalized saliency map.

(2) Multiple normalized saliency maps are averaged by pixels to obtain a final saliency map, where the final saliency map includes saliency of objects of different sizes.

In this way, the saliency map can show the image region based on which the Yolov3 performs the object detection.

Based on the final saliency map, the saliency score may be calculated through the following steps.

(1) A sum of pixel values of the pixels located within the marked region in the saliency map is calculated based on marks of an object position or important region, where the sum is recorded as A.

(2) A sum of pixel values of all pixels in the saliency map is recorded as B.

(3) The saliency score is calculated to be equal to A/B.

### (2) Application 2

In Application 2, the saliency score is used to improve an effect of automatic tuning of an ISP. Specifically, in Application 2, existing public data sets are used to reflect an improved effect of the automatic tuning of the ISP. KITTI is a commonly used data set in the field of autonomous driving, and object recognition may be performed based on the KITTI data set. In Application 2, the KITTI data set is divided into a training set (about 80%) for training a Yolov3 object detection model, and the remaining 20% of images for generating original images through ExpandNet before ISP processing. There are 256 original images used to tune an ISP parameter, and the remaining original images are used to test a detection effect of the model on sample images processed by the ISP. In order to eliminate randomness in the test as much as possible, 10 groups of 128 original image were randomly selected from the 20% data for ISP tuning, and the remaining original images are used for testing a tuning result.

The ISP simulator used in Application 2 includes a noise reducer based on bilateral filtering and Gaussian filtering, an edge enhancement based on high-pass filtering, and a tone mapper based on the Durand tone mapping algorithm. The ISP simulator can simulate several important functions of the ISP in Sony Fuji series. In order to simulate the discrete characteristics of parameters in a hardware ISP, parameters used in the ISP simulator are discrete.

In Application 2, a computer vision task is an object detection, and an evaluation score is a mAP@0.5 value (hereinafter referred to as mAP). The mAP value is calculated through the following steps: 1. setting a detection confidence threshold for a certain category, and eliminating model predictions below the threshold; 2. calculating an intersection area and an union area of the remaining prediction detection frame of the model and a manually marked detection frame, determining that the detection is correct in a case where the intersection area is greater than 0.5 times the union area, and otherwise determining that the detection is incorrect; 3. calculating a precision value and a recall value based on the number of correct detections and incorrect detections determined in step 2; and 4. adjusting the confidence threshold in step 1 to obtain a curve of the precision value with respect to a change of the recall value; calculating an area under the curve as an AP value of this category; and averaging AP values of all categories to get the mAP value. Calculation of a mAR is similar to the mAP, except that an average recall value is calculated, instead of calculating the area under the curve.

In Application 2, a CMA-ES optimizer is used as an automatic optimizer, and it is set that 12 sets of parameters are generated for the ISP each time, and an internal state of the optimizer is updated based on evaluation scores of these 12 sets of parameters simulated images. As for an optimization target of the optimizer, the existing technology only uses the mAP for optimization, but the present embodiment uses mAP+saliency score. In different situations, the mAP and the saliency score may use different weights.

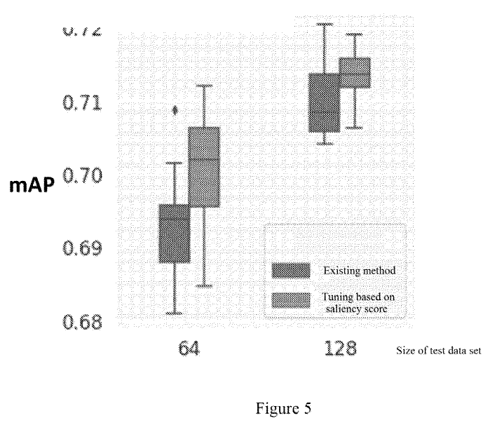

FIG. 4 shows prediction results of a predetermined model on a sample image after tuning through an existing method and tuning on an ISP based on a saliency score, respectively. As the saliency score may be calculated separately for different categories, FIG. 4 shows results of tuning based on saliency scores calculated based on a vehicle, a pedestrian, and a rider, respectively, as well as a result of tuning based on a saliency score calculated based on an average of the three categories. It can be seen that for 10 different sets of tuning and test data segmentation, the ISP tuning using the saliency score calculated based on any category outperforms that of the existing technology. Especially, the tuning with the vehicle-based saliency score can achieve the best result.

### (3) Application 3

In an early stage of ISP tuning, initial parameters are random. Therefore, a quality of a processed image is generally poor. The existing method takes a long time to obtain a relatively good tuning result. The existing method is to use a mAP for tuning. It is difficult to increase the mAP in the initial tuning stage, and therefore an optimizer cannot obtain enough information to decide a direction of parameter optimization. Since the saliency score changes directly according to the change of the image quality, there is still a good tuning signal in the early stage. Therefore, the embodiment of the present disclosure can guide the ISP tuning more quickly and improve a speed of automatic tuning of the ISP.

### (4) Application 4

In a case where a test data set is small, an evaluation indicator changes more sparsely. Therefore, the existing method performing optimization directly based on the evaluation indicator takes a long time to obtain a relatively good result. Since the saliency score changes directly according to the change of an image quality, image quality information can be provided to guide ISP tuning when the evaluation indicator remains unchanged. Hence, more improvement can be achieved than the existing method. Using the saliency score for ISP tuning can improve a utilization efficiency of the test data set and reduce an amount of data required in the test data set.

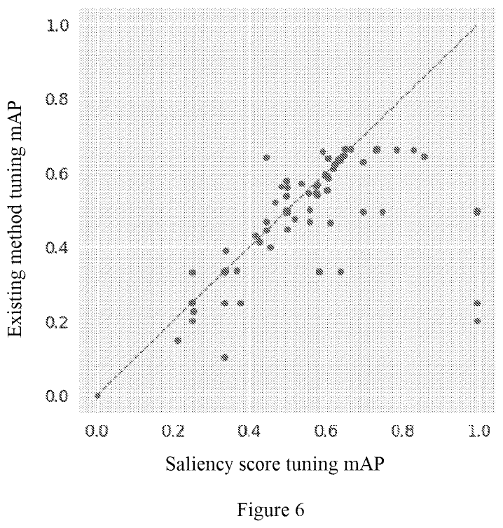

FIG. 5 shows a graph of comparison of tuning based on a saliency score with an existing method, when the size of a test data set changes. In FIG. 5, for two pairs of mAP plots corresponding to test dataset sizes of 64 and 128, the mAP located on the left in each pair of plots corresponds to the existing method, and the mAP located on the right corresponds to tuning based on the saliency score. As can be seen from FIG. 5, when the size of the test data set is reduced from 128 to 64, the improvement in mAP of tuning based on the saliency score is greater than that in the existing method.

### (5) Application 5

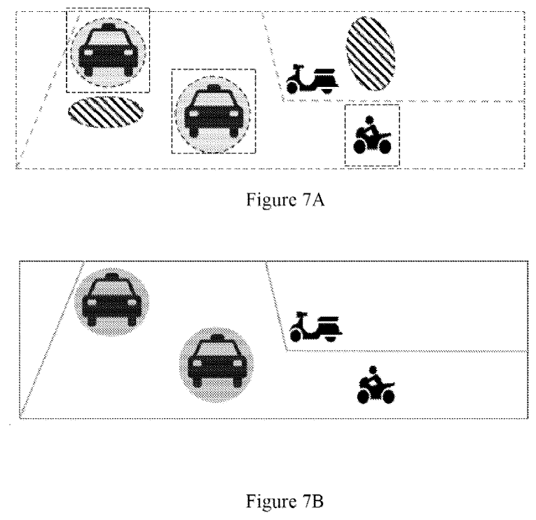

In a difficult scenario where the an evaluation indicator is difficult to improve, the evaluation indicator is difficult to improve. Therefore, the existing method of ISP tuning cannot obtain sufficient information on changes in the evaluation indicator, and it is difficult to achieve an ideal optimization result. Since the saliency score changes directly according to the change of a sample image quality, quality information of the sample image can be provided to guide ISP tuning when the evaluation indicator remains unchanged. Hence, more improvement can be achieved than the existing method. FIG. 6 shows a graph of comparison of tuning based on a saliency score with an existing method, when in a difficult scenario. In FIG. 6, for simplicity, the abscissa is abbreviated as saliency score tuning mAP, and the ordinate is abbreviated as existing method tuning mAP. The dotted line in FIG. 6 is a diagonal line. As shown in FIG. 6, 100 images from the above-mentioned difficult scenario are selected. From a comparison between the ISP tuning effect of the existing method and the ISP tuning effect of the saliency score, it can be seen that with the saliency score, most of the images have an improved mAP. On average, the mAP for the 100 images is 0.471 in the existing method, while the mAP for saliency score tuning is 0.523, achieving an improvement of more than 10%. It can be seen that using the saliency score for ISP tuning can improve a tuning effect for a difficult scenario.

### (6) Application 6

The accuracy requirements for different categories, sizes, and targets in different scenarios are different. Since the saliency map can be calculated based on a certain bounding box (prediction box), a corresponding saliency score can be calculated for a specific category, or a specific size, or a specific target, to improve a flexibility of ISP tuning. In other words, by using a saliency score for a specific category, the flexibility of the ISP tuning can be improved and adapted to different scenarios.

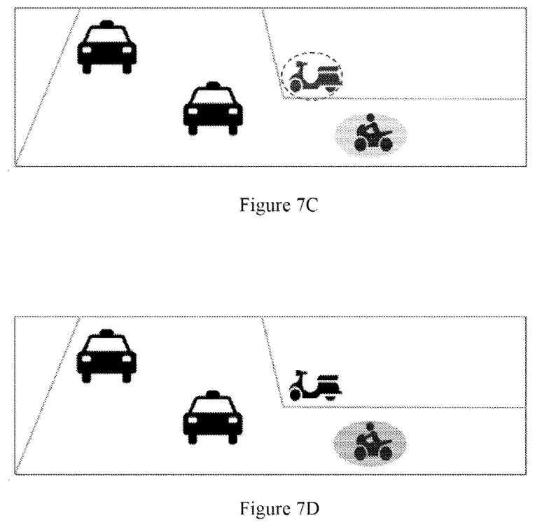

FIG. 7A to FIG. 7D show schematic diagrams of tuning by calculating a saliency score based on different objects and tuning through an existing method. In the tuning using the existing method in FIG. 7A, during a vehicle detection, in addition to the two vehicles, two regions covered by diagonal lines may be mistakenly detected. Therefore, there is a wrong attention on the saliency map. In the tuning with the saliency score calculated based on a vehicle in FIG. 7B, during the vehicle detection, two vehicles are correctly detected, and the two regions covered by diagonal lines in FIG. 7A are not detected. Therefore, the wrong attention on the saliency map in FIG. 7A is reduced. In the tuning using the existing method in FIG. 7C, during a rider detection, in addition to the one rider, a region enclosed by dotted lines is mistakenly detected. Therefore, there is a wrong attention on the saliency map. In the tuning with the saliency score calculated based on a rider in FIG. 7D, during the rider detection, the rider is correctly detected, and the region enclosed by dotted lines in FIG. 7C are not detected. Therefore, the wrong attention on the saliency map in FIG. 7C is reduced.

### (7) Application 7

When using a deep learning model, it is generally expected that the model makes decisions in a way that is consistent with humans and can be explained based on human experience. However, due to the complexity of deep learning, the determination basis sometimes differs from that of humans. Taking an object detection as an example, a large amount of training data comes from cities, and vehicles in cities generally appear on highways. Therefore, when the model detects a vehicle, a basis may not be a vehicle itself, but a highway. Hence, if an optimized image also comes from cities and optimization is performed only based on the mAP of the model, there may be a situation where the road surface is more conspicuous in an output image of an ISP. In this case, for a situation where a vehicle is on a rural dirt road, an effect of the vehicle detection of the model may be affected. In the present disclosure, the calculation of the saliency score is based on the manually marked object region. Taking the vehicle detection as an example, the salience score can be increased when the model focuses on a vehicle region, and the saliency score is reduced when the model focuses on a road. Therefore, the image outputted by the ISP does not highlight the road, but makes the vehicle itself more prominent. Therefore, by tuning the salience score, the result of the model on the image outputted by the ISP can be more consistent with human experience and have better interpretability. In other words, using the saliency score for ISP tuning can improve the model interpretability.

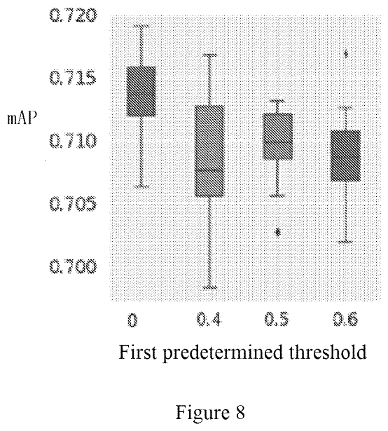

FIG. 8 is a schematic diagram illustrating an effect of tuning of an ISP based on a saliency score calculated according to different importance masks according to an embodiment of the present disclosure. Here, a sample image includes objects of different categories such as a vehicle, a pedestrian, and a rider. The task processing performed by the predetermined model is an object detection task. The predetermined first threshold used for generating the importance mask is set to 0, 0.4, 0.5, and 0.6, respectively. A pixel in the saliency map whose pixel value is greater than the first predetermined threshold is set to 1, and pixel values of the other pixels in the saliency map are set to 0, thereby generating different importance masks. FIG. 8 shows the mAP calculated by calculating saliency scores based on a vehicle, a pedestrian, and a rider, and performing the ISP tuning based on the calculated saliency scores.

As can be seen from FIG. 8, compared to the case where the predetermined first threshold is 0.4, 0.5, and 0.6, the mAP value is improved when the predetermined first threshold is 0 (which is equivalent to a case where the saliency score is calculated through Equation 3).

An image processing apparatus including the information processing apparatus is further provided in the present disclosure. The image processing apparatus may be implemented by a hardware product, and may be provided in a camera, a camcorder, and the like, for example.

Corresponding to the embodiments of the information processing apparatus, the present disclosure further provides embodiments of an information processing method.

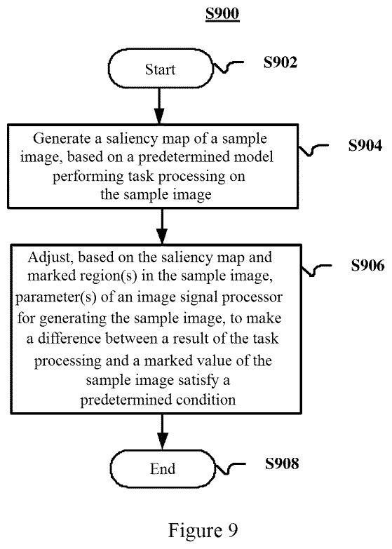

FIG. 9 is a flowchart illustrating an exemplary process of an information processing method S900 according to an embodiment of the present disclosure.

The information processing method S900 according to the embodiment of the present disclosure starts from S902.

In S904, a saliency map of a sample image is generated based on a predetermined model performing task processing on the sample image, where the saliency map reflects, when the predetermined model performs the tasking processing, a degree of importance on objects at different positions in the sample image.

In S906, parameter(s) of an image signal processor for generating the sample image is adjust, based on the saliency map and marked region(s) in the sample image, to make a difference between a result of the task processing and a marked value of the sample image satisfy a predetermined condition.

The information processing method S900 ends at S908. This method may be performed, for example, by the information processing apparatus 100 as described above. For specific details, reference may be made to the description of relevant processes of the information processing apparatus 100, which is not repeated here.

Basic principles of the present disclosure are described above in conjunction with the specific embodiments. However, it should be noted that those skilled in the art can understand that all or any of steps or components of the methods and apparatuses of the present disclosure may be implemented in any computing device (including processors, storage media, and the like) or a network of computing devices in a form of hardware, firmware, software or a combination thereof. Such implementation can be realized by those skilled in the art after reading the description of the present disclosure, by utilizing basic knowledge of circuit design or basic programming skills.

Moreover, a program product storing machine-readable instruction codes is further provided according to an embodiment of the present disclosure. The instruction codes, when read and executed by a machine, may implement the methods according to the embodiments of the present disclosure.

Accordingly, a storage medium for carrying the program product storing the machine-readable instruction codes is further included in the present disclosure. The storage medium includes, but is not limited to, a floppy disk, an optical disk, a magneto-optical disk, a storage card, a memory stick, and the like.

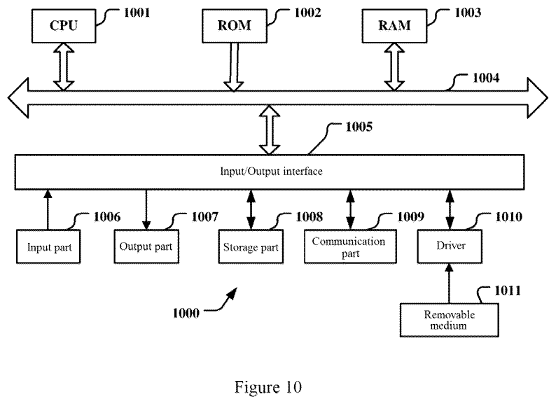

In a case of implementing the embodiments of the present disclosure in software or firmware, the program consisting of the software is mounted to a computer with a dedicated hardware structure (such as a general-purpose computer 1000 as shown in FIG. 10) from the storage medium or network. The computer, when mounted with various programs, performs various functions.

In FIG. 10, a central processing unit (CPU) 1001 executes various processes according to a program stored in a read-only memory (ROM) 1002 or a program loaded from a storage part 1008 to a random-access memory (RAM) 1003. In the RAM 1003, data required for the CPU 1001 to perform various processes or the like is stored as necessary. The CPU 1001, the ROM 1002 and the RAM 1003 are connected to each other via a bus 1004. An input/output interface 1005 is connected to the bus 1004.

The following components are connected to the input/output interface 1005: an input part 1006 (including a keyboard, a mouse, and the like), an output part 1007 (including a display, such as a cathode ray tube (CRT) and a liquid crystal display (LCD), a loudspeaker, and the like), a storage part 1008 (including a hard disk and the like), and a communication part 1009 (including a network interface card, such as a LAN card, and a modem). The communication part 1009 performs communication processing via a network, such as the Internet. A driver 1010 may be connected to the input/output interface 1005 as needed. A removable medium 1011, such as a magnetic disk, an optical disk, a magnetic optical disk, and a semiconductor memory, is mounted to the driver 1010 as required, so that a computer program read therefrom is mounted to the storage part 1008 as required.

In a case that the above processes are implemented by software, the program consisting of the software is mounted from a network, such as the Internet, or from a storage medium, such as the removable medium 1011.

Those skilled in the art should understood that, the storage medium is not limited to the removable medium 1011, as shown in FIG. 10, which stores a program and is distributed separately from the apparatus so as to provide the program for a user. Examples of the removable medium 1011 includes a magnetic disk (including a floppy disk (registered trademark)), an optical disk (including a compact disk read-only memory (CD-ROM) and a Digital Versatile Disk (DVD)), a magneto-optical disk (including a mini disk (MD) (registered trademark)), and a semiconductor memory. Alternatively, the storage medium may be the ROM 1002, the hard disk contained in the storage part 1008, or the like. The storage medium stores a program and is distributed to the user along with an apparatus in which the storage medium is incorporated.

It should be further noted that components or steps in the apparatus, method and system of the present disclosure can be decomposed and/or recombined. Such decomposition and/or recombination should be considered equivalents of the present disclosure. Furthermore, steps for executing the above processes may naturally be executed in a chronological order as described, but do not necessarily need to be executed in the chronological order. Certain steps may be performed in parallel with or independently of each other.

Finally, it should be noted that terms “include”, “comprise” or any other variants are intended to be non-exclusive. Therefore, a process, method, article or device including a series of elements includes not only the elements but also other elements that are not enumerated, or further includes elements inherent to the process, method, article or device. In addition, unless expressively limited otherwise, the statement “comprising (including) a (n) . . . ” does not exclude existence of other similar elements in the process, method, article or device.

Although the embodiments of the present disclosure are described in detail above with reference to the accompanying drawings, it should be understood that the embodiments are only for illustrating the present disclosure and do not constitute a limitation to the present disclosure. For those skilled in the art, various modifications and changes can be made to the embodiments without departing from the spirit and scope of the present disclosure. Therefore, the scope of the present disclosure is limited by only the appended claims and equivalents thereof.

The present technology may be implemented as the following solutions.

Note 1. An information processing apparatus, comprising:
processing circuitry configured to:
generate a saliency map of a sample image, based on a predetermined model performing task processing on the sample image, wherein the saliency map reflects, when the predetermined model performs the tasking processing, a degree of importance on objects at different positions in the sample image, and
adjust, based on the saliency map and marked region(s) in the sample image, parameter(s) of an image signal processor for generating the sample image, to make a difference between a result of the task processing and a marked value of the sample image satisfy a predetermined condition.

Note 2. The information processing apparatus according to note 1, wherein the processing circuitry is configured to: calculate a saliency score corresponding to the sample image, based on the saliency map and the marked region(s), and adjust the parameter(s) based on the saliency score.

Note 3. The information processing apparatus according to note 2, wherein the processing circuitry is configured to:
calculate a sum of pixel values of pixels located within the marked region(s) in the saliency map, as a first value, and
calculate a sum of pixel values of all pixels in the saliency map, as a second value, and
calculate a ratio of the first value to the second value, as the saliency score.

Note 4. The information processing apparatus according to note 2, wherein the processing circuitry is configured to:
generate, based on the saliency map, an importance mask for reflecting importance of pixels in the saliency map, and
calculate the saliency score based on the importance mask and the marked region(s).

Note 5. The information processing apparatus according to note 4, wherein
the processing circuitry is configured to: retain pixel(s) in the saliency map whose pixel values are greater than a first predetermined threshold, and set the pixel value of any other pixels in the saliency map to 0, thereby generating the importance mask.

Note 6. The information processing apparatus according to note 5, wherein
in the importance mask, the pixel value of the retained pixel(s) is the pixel value of the pixel at a corresponding position in the saliency map, or a value calculated based on the pixel value of the pixel at the corresponding position in the saliency map.

Note 7. The information processing apparatus according to note 5 or 6, wherein
the processing circuitry is configured to: calculate a first quantity of pixels in the importance mask that are located within the marked region(s) and whose pixel values are greater than a second predetermined threshold,
calculate a second quantity of pixels in the importance mask whose pixel values are greater than the predetermined second threshold, and
calculate a ratio of the first quantity to the second quantity, as the saliency score.

Note 8. The information processing apparatus according to any one of notes 2 to 7, wherein the processing circuitry is configured to adjust the parameter(s) based on the saliency score and an evaluation indicator for the task processing of the predetermined model.

Note 9. The information processing apparatus according to note 8, wherein the processing circuitry is configured to adjust the parameter(s) based on a sum of a first value and a second value, where the first value is obtained by multiplying the saliency score by a first predetermined weight, and the second value is obtained by multiplying the evaluation indicator by a second predetermined weight.

Note 10. The information processing apparatus according to note 9, wherein the first predetermined weight is a ratio of the number of pixels located in the marked region in the saliency map to the number of all pixels in the saliency map.

Note 11. The information processing device according to any one of notes 2 to 10, wherein the marked region is at least a part of regions which are from regions for marking a plurality of objects in the sample image and correspond to at least a part of the plurality of objects.

Note 12. The information processing apparatus according to any one of notes 2 to 11, wherein the processing circuitry is configured to:
obtain at least one heat map by using a machine learning interpretation tool based on an output obtained after inputting the sample image into the predetermined model; and
generate the saliency map based on the at least one heat map.

Note 13. The information processing apparatus according to note 12, wherein
the size of the saliency map is the same as the size of the sample image, and
a pixel value of a pixel in the saliency map reflects a contribution of the pixel to the task processing.

Note 14. The information processing apparatus according to note 12 or 13, wherein
in a case where the at least one heat map comprises only one heat map, the saliency map is generated by normalizing pixel values of pixels in the one heat map, or
in a case where the at least one heat map comprises a plurality of heat maps obtained for different objects comprised in the sample image, the saliency map is generated by normalizing pixel values of pixels in the plurality of heat maps and averaging the normalized pixel values of pixels at a same position in the plurality of heat maps.

Note 15. The information processing apparatus according to any one of notes 12 to 14, wherein
the machine learning interpretation tool comprises at least one of Grad-CAM, Grad-CAM++, XGrad-CAM, Ablation-CAM, Score-CAM, and guided back-propagation.

Note 16. The information processing apparatus according to any one of notes 2 to 15, wherein the processing circuitry is configured to iteratively adjust the parameter(s) of the image signal processor with a goal of increasing the saliency score.

Note 17. The information processing apparatus according to any one of notes 1 to 16, wherein
in a case where the task processing is a classification task, the marked region is a region for determining a type of the sample image.

Note 18. The information processing apparatus according to any one of notes 1 to 16, wherein
in a case where the task processing is an object detection task, the marked region is a bounding box marked as an object in the sample image.

Note 19. The information processing apparatus according to any one of notes 1 to 18, wherein
the predetermined model is a computer vision task model.

Note 20. An image processing apparatus, comprising the information processing apparatus according to any one of notes 1 to 19.

Note 21. An information processing method, comprising:
generating a saliency map of a sample image, based on a predetermined model performing task processing on the sample image, wherein the saliency map reflects, when the predetermined model performs the tasking processing, a degree of importance on objects at different positions in the sample image, and
adjusting, based on the saliency map and marked region(s) in the sample image, parameter(s) of an image signal processor for generating the sample image, to make a difference between a result of the task processing and a marked value of the sample image satisfy a predetermined condition.

Note 22. A computer-readable storage medium storing computer-executable instructions, wherein the computer-executable instructions, when executed, cause the information processing method according to note 21 to be performed.

1. An information processing apparatus, comprising
at least one processor; and
at least one memory including computer program code, where the at least one memory and the computer program code are configured, with the at least one processor, to cause the information processing apparatus to at least:
generate a saliency map of a sample image, based on a predetermined model performing task processing on the sample image, wherein the saliency map reflects, when the predetermined model performs the tasking processing, a degree of importance on objects at different positions in the sample image, and
adjust, based on the saliency map and marked region(s) in the sample image, parameter(s) of an image signal processor for generating the sample image, to make a difference between a result of the task processing and a marked value of the sample image satisfy a predetermined condition.

2. The information processing apparatus according to claim 1, wherein the at least one memory and the computer program code are configured, with the at least one processor, to cause the information processing apparatus to: calculate a saliency score corresponding to the sample image, based on the saliency map and the marked region(s), and adjust the parameter(s) based on the saliency score.

3. The information processing apparatus according to claim 2, wherein the at least one memory and the computer program code are configured, with the at least one processor, to cause the information processing apparatus to:
calculate a sum of pixel values of pixels located within the marked region(s) in the saliency map, as a first value, and
calculate a sum of pixel values of all pixels in the saliency map, as a second value, and
calculate a ratio of the first value to the second value, as the saliency score.

4. The information processing apparatus according to claim 2, wherein the at least one memory and the computer program code are configured, with the at least one processor, to cause the information processing apparatus to:
generate, based on the saliency map, an importance mask for reflecting importance of pixels in the saliency map, and
calculate the saliency score based on the importance mask and the marked region(s).

5. The information processing apparatus according to claim 4, wherein
the at least one memory and the computer program code are configured, with the at least one processor, to cause the information processing apparatus to: retain pixel(s) in the saliency map whose pixel values are greater than a first predetermined threshold, and set the pixel value of any other pixels in the saliency map to 0, thereby generating the importance mask.

6. The information processing apparatus according to claim 5, wherein
in the importance mask, the pixel value of the retained pixel(s) is the pixel value of the pixel at a corresponding position in the saliency map, or a value calculated based on the pixel value of the pixel at the corresponding position in the saliency map.

7. The information processing apparatus according to claim 5, wherein
the at least one memory and the computer program code are configured, with the at least one processor, to cause the information processing apparatus to: calculate a first quantity of pixels in the importance mask that are located within the marked region(s) and whose pixel values are greater than a second predetermined threshold,
calculate a second quantity of pixels in the importance mask whose pixel values are greater than the predetermined second threshold, and
calculate a ratio of the first quantity to the second quantity, as the saliency score.

8. The information processing apparatus according to claim 2, wherein the at least one memory and the computer program code are configured, with the at least one processor, to cause the information processing apparatus to adjust the parameter(s) based on the saliency score and an evaluation indicator for performing the task processing using the predetermined model.

9. The information processing apparatus according to claim 8, wherein the at least one memory and the computer program code are configured, with the at least one processor, to cause the information processing apparatus to adjust the parameter(s) based on a sum of a first value and a second value, where the first value is obtained by multiplying the saliency score by a first predetermined weight, and the second value is obtained by multiplying the evaluation indicator by a second predetermined weight.

10. The information processing apparatus according to claim 9, wherein the first predetermined weight is a ratio of the number of pixels located in the marked region in the saliency map to the number of all pixels in the saliency map.

11. The information processing device according to claim 2, wherein the marked region is at least a part of regions which are from regions for marking a plurality of objects in the sample image and correspond to at least a part of the plurality of objects.

12. The information processing apparatus according to claim 2, wherein the at least one memory and the computer program code are configured, with the at least one processor, to cause the information processing apparatus to:
obtain at least one heat map by using a machine learning interpretation tool based on an output obtained after inputting the sample image into the predetermined model; and
generate the saliency map based on the at least one heat map.

13. The information processing apparatus according to claim 12, wherein
the size of the saliency map is the same as the size of the sample image, and
a pixel value of a pixel in the saliency map reflects a contribution of the pixel to the task processing.

14. The information processing apparatus according to claim 12, wherein
in a case where the at least one heat map comprises only one heat map, the saliency map is generated by normalizing pixel values of pixels in the one heat map, or
in a case where the at least one heat map comprises a plurality of heat maps obtained for different objects comprised in the sample image, the saliency map is generated by normalizing pixel values of pixels in the plurality of heat maps and averaging the normalized pixel values of pixels at a same position in the plurality of heat maps.

15. The information processing apparatus according to claim 12, wherein
the machine learning interpretation tool comprises at least one of Grad-CAM, Grad-CAM++, XGrad-CAM, Ablation-CAM, Score-CAM, and guided back-propagation.

16. The information processing apparatus according to claim 2, wherein the at least one memory and the computer program code are configured, with the at least one processor, to cause the information processing apparatus to iteratively adjust the parameter(s) of the image signal processor with a goal of increasing the saliency score.

17. The information processing apparatus according to claim 1, wherein
in a case where the task processing is a classification task, the marked region is a region for determining a type of the sample image.

18. The information processing apparatus according to claim 1, wherein
in a case where the task processing is an object detection task, the marked region is a bounding box marked as an object in the sample image.

19. (canceled)

20. An image processing apparatus, comprising the information processing apparatus according to claim 1.

21. An information processing method, comprising:
generating a saliency map of a sample image, based on a predetermined model performing task processing on the sample image, wherein the saliency map reflects, when the predetermined model performs the tasking processing, a degree of importance on objects at different positions in the sample image, and
adjusting, based on the saliency map and marked region(s) in the sample image, parameter(s) of an image signal processor for generating the sample image, to make a difference between a result of the task processing and a marked value of the sample image satisfy a predetermined condition.

22. (canceled)
